(19) United States
(12) Patent Application Publication
(10) Pub. No.: US 2011/0102630 A1
(43) Pub. Date: May 5, 2011

(54) IMAGE CAPTURING DEVICES USING DEVICE LOCATION INFORMATION TO ADJUST IMAGE DATA DURING IMAGE SIGNAL PROCESSING

(76) Inventor: Jason Rukes, San Francisco, CA (US)

(21) Appl. No.: 12/610,203

(22) Filed: Oct. 30, 2009

(51) Int. Cl. H04N 9/73

(52) U.S. Cl. 348/223.1; 348/E09.051

(57) ABSTRACT

Several methods and apparatuses for adjusting image data during image processing based on device specific information (e.g., location, orientation) for image capturing devices are described. In one embodiment, after having powered on the device and placing it in image capture mode, a location function determines location data of the device including a regional location. Next, an image capture function begins execution which captures one or more images of a scene that is before the camera lens. Next, adaptive image signal processing can occur based on the location data. For example, color adjustments (e.g., white balance, hue, saturation), sharpening, and contrast parameters for a given region may be adjusted during the image processing.

### FIELD OF THE INVENTION

Embodiments of the invention are generally related to image capturing devices and more particularly to devices having device location information to augment and adjust image data during image signal processing.

### BACKGROUND

Image capturing devices include cameras, portable handheld electronic devices, and other electronic devices. These image capturing devices have various image parameters such as color adjustments including white balance and saturation of colors. Users in different regions of the world (e.g., United States, Asia) may have different color preferences. Users in one region (e.g., China) prefer their images to have a particular color cast (e.g., more green) than users in another region.

One prior approach for building image capturing devices includes having a different color profile for different regions and determining, before manufacturing of a device is completed, a region of the world where the device will be sold and used. The device is then set by the manufacturer with a predetermined color profile based on the region in which the device will be sold. This approach requires several color profiles and requires the devices to be set for a region in the manufacturing process by the manufacturer.

### SUMMARY

Several methods and apparatuses for adjusting image data during image processing based on device specific information (e.g., location, orientation) for image capturing devices are described. In one embodiment, after having powered on the device and placing it in image capture mode, a location function determines location data (e.g., data obtained from, for example, a global positioning system (GPS) receiver) of the device including a regional location. Next, an image capture function begins execution which captures one or more images of a scene that is before the camera lens. Next, adaptive image signal processing can occur based on the location data. For example, color adjustments (e.g., white balance, hue, saturation), sharpening, and contrast parameters for a given region (determined from the location data) may be adjusted during the image processing.

In an embodiment, the adaptive image signal processing can occur based on the location data upon initial operation of the device and this location data is used for all subsequent operations (or at least until the device is reset). For example, a device may begin initial operation in a particular region. In this case, regional settings are applied based on the location data that indicates the particular region or location for all subsequent operations until a reset is performed. In some embodiments, the adaptive image signal processing can occur based on the location data each time the device is powered on and placed into the image capture mode or each time the image capture function is executed.

In another embodiment, orientation data and time of day are used for adaptively adjusting image data during image signal processing. The device location, orientation data, and time of day can be used to determine that the device is facing a particular direction to capture one or more images of a particular scene or landmark.

Other embodiments are also described. Other features of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows a portable handheld device having a built-in digital camera, in accordance with one embodiment.

FIG. 2 illustrates a flow diagram of operations for adjusting image data during image signal processing using device specific information (e.g., regional location of the device), in accordance with some embodiments.

FIG. 3 illustrates a detailed flow diagram of operations for adjusting image data during image signal processing using device specific information (e.g., regional location of the device, orientation of the device), in accordance with some embodiments.

FIG. 4 illustrates a flow diagram of operations for adjusting settings for an image capturing device in accordance with one embodiment.

FIG. 5 illustrates a flow diagram of operations for capturing images based on previous settings for an image capturing device in accordance with one embodiment.

FIG. 6 shows an image capturing device, in accordance with one embodiment.

FIG. 7 shows an embodiment of a wireless image capturing device.

FIG. 8 shows an example of a data processing system, according to an embodiment.

### DETAILED DESCRIPTION

Several methods and apparatuses for adjusting image data during image processing based on device specific information (e.g., location, orientation) for image capturing devices are described. In one embodiment, upon device initialization, a GPS function (or other position location function such as location functions derived through measurements of cellular telephone signals, etc.) determines GPS (or other location) data including a regional location. Next, the device is placed in an image capture mode and an image capture function begins execution which captures one or more images of a scene that is before the camera lens. Next, adaptive image signal processing can occur based on the GPS (or other location) data. For example, color adjustments (e.g., white balance, hue, saturation), sharpness, and contrast parameters for a given region (e.g., a given country or set of countries) may be adjusted during the image processing. The location data can be used to determine a country or other regional location information based on a mapping between the location data (e.g., GPS coordinates or cellular tower locations) and a particular country or set of countries. It will be understood that a GPS receiver or other location determination system will produce location data that can be converted through a mapping operation to regional information; for example, a point on a map (such as a GPS longitude and latitude) can be converted to a city, a county, a state, a country or set of countries such as a continent or portion of a continent.

In some embodiments, the adaptive image signal processing can occur based on the GPS data (or other location data) each time upon powering the device and placing it in the image capture mode or each time the image capture function is executed.

In another embodiment, orientation data and time of day are used for adaptively adjusting image data during image signal processing. The device location, orientation data, and time of day can be used to determine that the device is facing a particular direction (at a particular time of day) to capture one or more images of a particular scene or landmark.

In another embodiment, operations for adjusting settings for an image capturing device are described. After having powered on the device and placing it in image capture mode, a GPS receiver (or other location system) integrated with the device determines data regarding location of the device. Processing logic determines one or more regulations associated with the location of the device. The processing logic based on the one or more regulations adjusts visual or audible settings during image capture of one or more images.

In this section several preferred embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

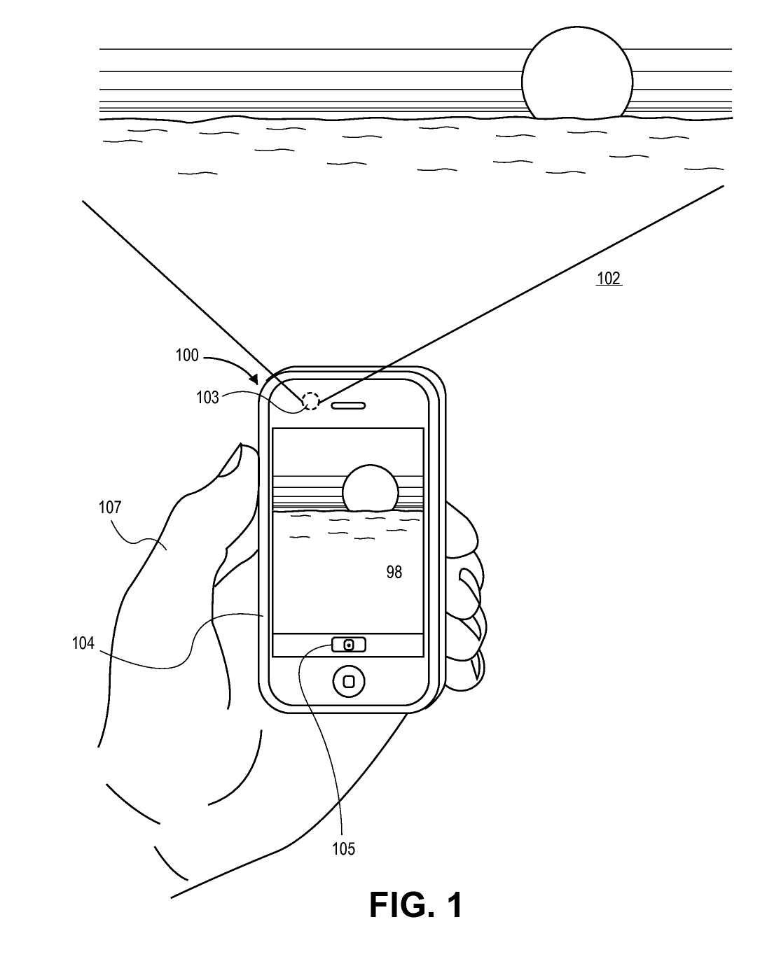

FIG. 1 shows a portable image capturing device 100 having a built-in digital camera and GPS receiver in accordance with one embodiment. In this example, the portable device 100 is shown while it is held in the user's hand 107. The device 100 may be an IPHONE device by Apple Inc., of Cupertino, Calif. Alternatively, it could be any other electronic device that has a built-in digital camera and GPS receiver or other location determination system. The built-in digital camera includes a lens 103 located in this example on the back face of the device 100. The lens may be a fixed optical lens system or it may have focus and optical zoom capability. Although not depicted in FIG. 1, inside the device 100 are an electronic image sensor and associated hardware circuitry and running software that can capture a digital still image or video of a scene 102 that is before the lens 103.

The digital camera functionality of the device 100 optionally includes an electronic or digital viewfinder. The viewfinder can display live, captured video or still images of the scene 102 that is before the camera, on a portion of the touch sensitive screen 104 as shown. In this case, the digital camera also includes a soft or virtual shutter button whose icon 105 is displayed by the screen 104, directly below the viewfinder image area. As an alternative or in addition, a physical shutter button may be implemented in the device 100. The device 100 includes all of the needed circuitry and/or software for implementing the digital camera functions of the electronic viewfinder, shutter release, and adjusting image data during image signal processing as described below.

In FIG. 1, the scene 102 is displayed on the screen. The scene 102 includes an upper section 97 (e.g., sunset sky) and a lower section (e.g., ocean).

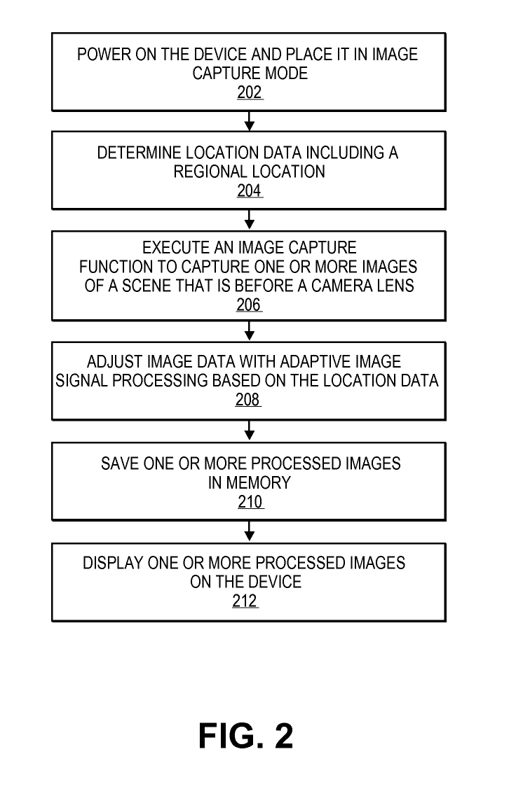

FIG. 2 illustrates a flow diagram of operations for adjusting image data during image signal processing using device specific information (e.g., regional location of the device) in accordance with some embodiments. After having powered on the device 100 and placing it in image capture mode at block 202, a location function (e.g., GPS function) determines location data including a regional location at block 204. Alternatively, the location function may be implemented prior to the image capture mode. The location function may be optionally implemented depending on a preference of a user. Next, an image capture function begins execution which captures one or more images of a scene 102 that is before the camera lens 103 at block 206. Next, image data can be adjusted using adaptive image signal processing that is based on the location data at block 208. For example, color adjustments (e.g., white balance, hue, saturation), sharpness, and contrast parameters for a given region may be adjusted during the image processing. The one or more processed images are then saved in memory at block 210. The one or more processed images can then be displayed on the device at block 212.

In one embodiment, the adaptive image signal processing can occur based on the location data only upon initial operation of the device and all subsequent operations use this location data until the device is reset. For example, a device may begin initial operation in a particular region. In this case, regional settings are applied based on the location data that indicates the particular region or location.

In another embodiment, the adaptive image signal processing can occur based on the location data upon each time that the device is powered on and placed in the image capture mode. Alternatively, the adaptive image signal processing can occur based on the location data each time the image capture function is executed. For example, a device may begin initial operation in a first region. In this case, first regional settings are applied based on the location data that indicates the first region. Subsequently, the location data (obtained in only this initial operation) may indicate that the device is located in a second region. In this case, second regional settings are applied. Additionally, one or more settings within a region may be altered based on the location data. The first region may be the United States of America which may have a first regional setting or it may be China, etc. Location data may indicate whether a device is located in a particular state (e.g., Alaska, Hawaii, Arizona). Each state or some grouping of states may have different settings within the first regional setting. For example, Alaska may have primarily snow or ocean scenes. Hawaii may have primarily ocean or beach scenes. Arizona may have primarily desert scenes.

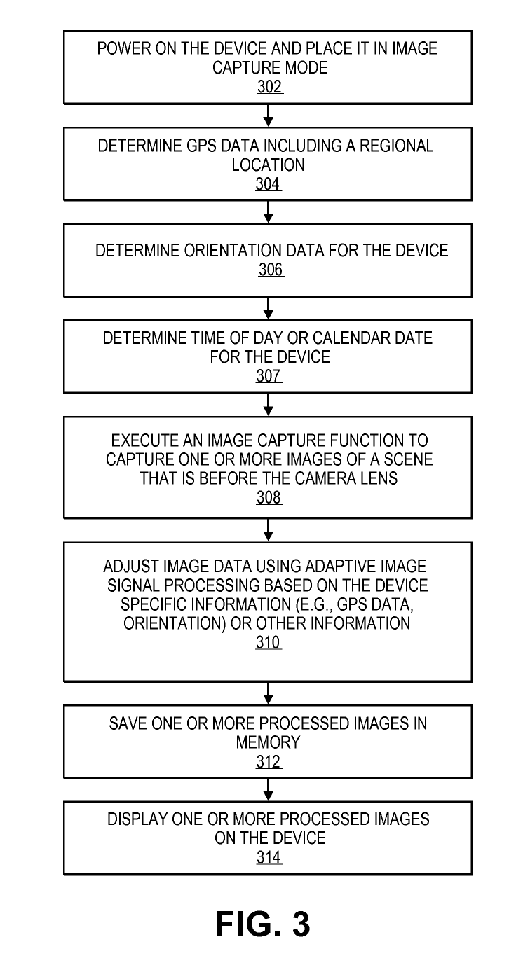

FIG. 3 illustrates a detailed flow diagram of operations for adjusting image signal processing using device specific information (e.g., regional location of the device, orientation of the device) or other information (e.g., time of day, season or calendar date) in accordance with certain embodiments. After having powered on the device 100 and placing it in image capture mode at block 302, device specific information can be determined depending on user preference. A GPS function determines GPS data including a regional location at block 304. The GPS data may include latitude coordinates, longitude coordinates, altitude, bearing, accuracy data, and place names. An orientation function may also be optionally implemented to determine orientation data for the device at block 306. A time or calendar date may optionally be determined for the device at block 307. The GPS and orientation functions may be optionally implemented depending on a preference of a user. Next, an image capture function begins execution which captures one or more images of a scene 102 that is before the camera lens 103 at block 308. Next, image data associated with the captured images can be adjusted using adaptive image signal processing based on the device specific information (e.g., GPS data, orientation) or other information (e.g., time of day, calendar date) at block 310. For example, color adjustments (e.g., white balance, hue, saturation), sharpness (e.g., resolution, acutance), and contrast parameters for a given region may be adjusted during the image processing. Acutance, which may be referred to as sharpening, relates to transitions between edges such as when an edge changes from one brightness level to another. However, increasing the sharpening may increase noise and also cause a longer frame rate because of the increased noise. Contrast parameters include a gamma correction for properly displaying the images on a display of the device. More or less details can be provided for shadows and highlights in images using contrast parameters.

In one embodiment, the following table shows an exemplary image parameter having predefined settings for different regions A, B, C, etc. For example, region A may represent the United States of America, region B may represent Europe, and region C may represent China.

| Region | Saturation |
|---|---|
| A | Nominal |
| B | Less |
| C | More |
| . . . | . . . |

The one or more processed images can be saved in memory at block 312. The one or more processed images can be displayed on the device at block 314.

The image signal processing, which may be executed by a processing circuit or processing logic, can adaptively adjust image parameters based on device specific information. The processing logic may include hardware (circuitry, dedicated logic, etc.), software (such as is run on a general purpose computer system or a dedicated machine or a device), or a combination of both. Pixel values are read from the image sensors to generate image data. Frames are sent at a certain time interval (e.g., 1/15 of a second) to the processing logic.

In one embodiment, the adaptive image signal processing can occur based on the GPS data upon initial operation of the device. For example, a device may begin initial operation in a particular region. In this case, regional settings are applied based on the GPS data that indicates the particular region or location. In some embodiments, the adaptive image signal processing can occur based on the GPS data upon powering the device and placing it in the image capture mode or each time the image capture function is executed.

The GPS data may indicate where the device is currently located. A user with a device in China may have a preference for greener colors. A user with a device in the United States of America may have a preference for vibrant colors and more sharpening. The orientation data may indicate a device orientation (e.g., landscape, portrait, compass direction) with respect to a reference.

In one embodiment, the processing logic may determine that the device is facing west based on a known time of day, location of the device, and compass direction of the device. A white balance adjustment that typically makes a scene appear less orange would not be allowed or disabled because of this device specific information (e.g., device facing west to capture images of a sunset). In other embodiments, the device may include a GPS receiver that detects a GPS signal. The strength of the GPS signal indicates whether the device is indoors or outdoors. Image parameters can be adjusted based on this information.

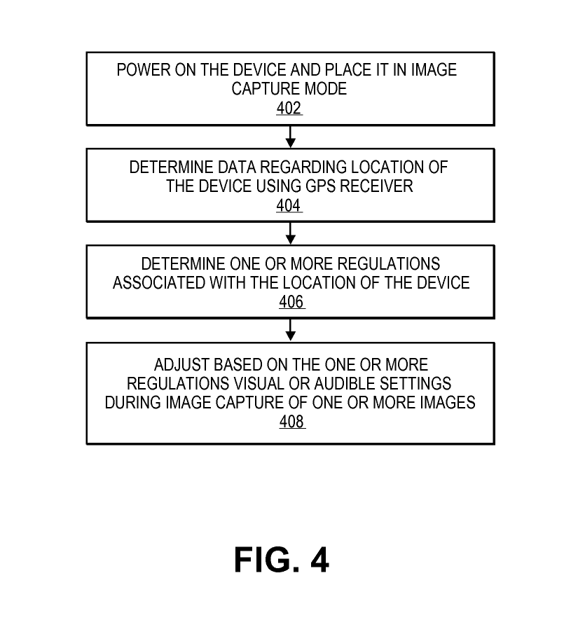

FIG. 4 illustrates a flow diagram of operations for adjusting settings for an image capturing device in accordance with one embodiment. After having powered on the device 100 and placing it in image capture mode at block 402, a GPS receiver integrated with the device determines data regarding location of the device at block 404. Processing logic determines one or more regulations associated with the location of the device at block 406. The processing logic based on the one or more regulations adjusts visual or audible settings during image capture of one or more images at block 408. In an embodiment, adjusting a visual setting includes flashing a light during image capture of one or more images. Adjusting an audible visual setting may include generating an audible noise during image capture of one or more images.

In one embodiment, the adjustment of the settings can occur based on the GPS data upon initial operation of the device. For example, a device may begin initial operation in a particular region. In this case, regional regulations are applied based on the GPS data that indicates the particular region or location. In some embodiments, the adjustment of the settings can occur based on the GPS data upon powering the device and placing it in the image capture mode or each time the image capture function is executed.

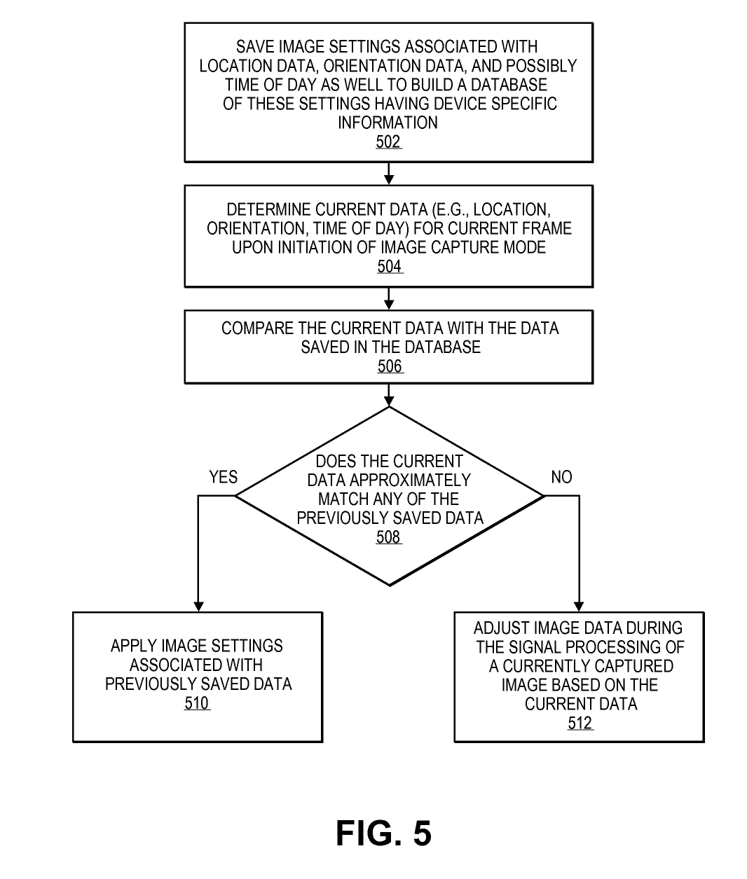

FIG. 5 illustrates a flow diagram of operations for capturing images based on previous settings for an image capturing device in accordance with one embodiment. Operations 202-212 can be performed as discussed above in conjunction with FIG. 2. Processing logic saves image settings associated with location data, orientation data, and possibly time of day as well to build a database of these settings having device specific information at block 502. Processing logic determines current data (e.g., location, orientation, time of day) for a current frame or upon initiation of image capture mode at block 504. Processing logic compares the current data with the data saved in the database at block 506.

The processing logic determines if the current data approximately matches any of the previously saved data at block 508. The processing logic then applies image settings associated with previously saved data if this data approximately matches the current data at block 510. In this manner, image settings from previous images can be applied to reduce the time required for image signal processing.

If no match is found at block 508, then the processing logic uses the current data during the signal processing of a currently captured image to adjust image settings at block 512 in a similar manner as described above in operations 206 and 208. For example, a user may frequently capture images at the same location with the same orientation at the same time of day (e.g., facing west at sunset near a particular ocean). The database enables previous settings to be applied during the image signal processing.

In some embodiments, the operations of the methods disclosed can be altered, modified, combined, or deleted. For example, the order of block 204 and block 206 can be switched. Blocks 304, 306, 307, and 308 can occur in one or more different sequences with 304, 306, and 307 being optional. Other methods having various operations that have been disclosed within the present disclosure can also be altered, modified, rearranged, collapsed, combined, or deleted.

Many of the methods in embodiments of the present invention may be performed with a digital processing system, such as a conventional, general-purpose computer system. Special purpose computers, which are designed or programmed to perform only one function, may also be used.

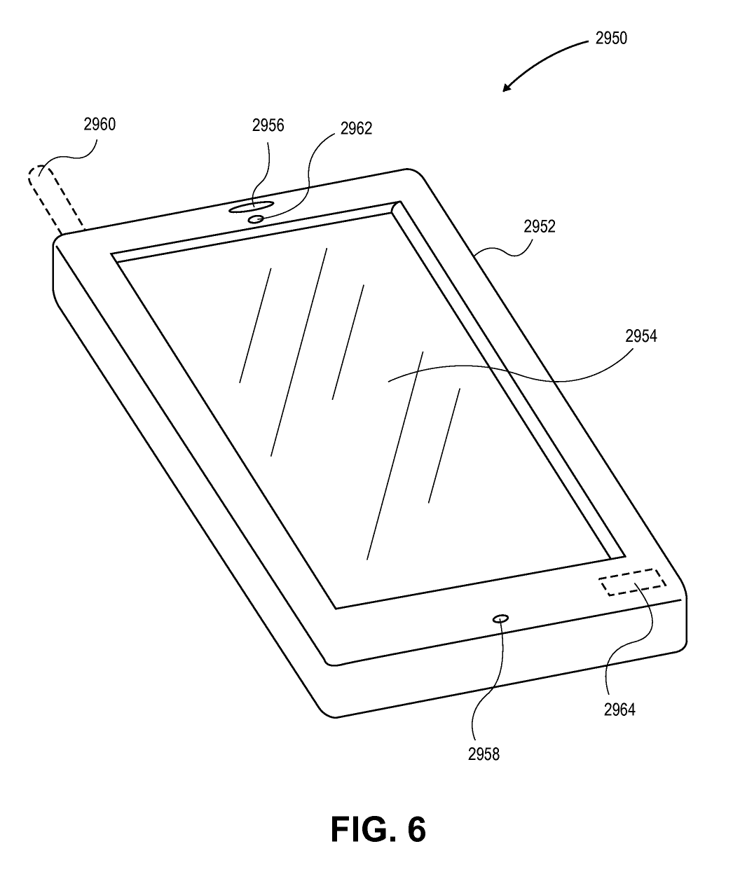

In some embodiments, the methods, systems, and apparatuses of the present disclosure can be implemented in various devices including electronic devices, consumer devices, data processing systems, desktop computers, portable computers, wireless devices, cellular devices, tablet devices, handheld devices, multi touch devices, multi touch data processing systems, any combination of these devices, or other like devices. FIGS. 6-8 illustrate examples of a few of these devices, which are capable of capturing still images and video to implement the methods of the present disclosure.

FIG. 6 shows an image capturing device 2950 in accordance with one embodiment of the present invention. The device 2950 may include a housing 2952, a display/input device 2954, a speaker 2956, a microphone 2958 and an optional antenna 2960 (which may be visible on the exterior of the housing or may be concealed within the housing). The device 2950 also may include a proximity sensor 2962 and a GPS unit 2964. The device 2950 may be a cellular telephone or a device which is an integrated PDA and a cellular telephone or a device which is an integrated media player and a cellular telephone or a device which is both an entertainment system (e.g. for playing games) and a cellular telephone, or the device 2950 may be other types of devices described herein. In one particular embodiment, the device 2950 may include a cellular telephone and a media player and a PDA, all contained within the housing 2952. The device 2950 may have a form factor which is small enough that it fits within the hand of a normal adult and is light enough that it can be carried in one hand by an adult. It will be appreciated that the term “portable” means the device can be easily held in an adult user's hands (one or both); for example, a laptop computer, an iPhone, and an iPod are portable devices.

In certain embodiments of the present disclosure, the device 2950 can be used to implement at least some of the methods discussed in the present disclosure.

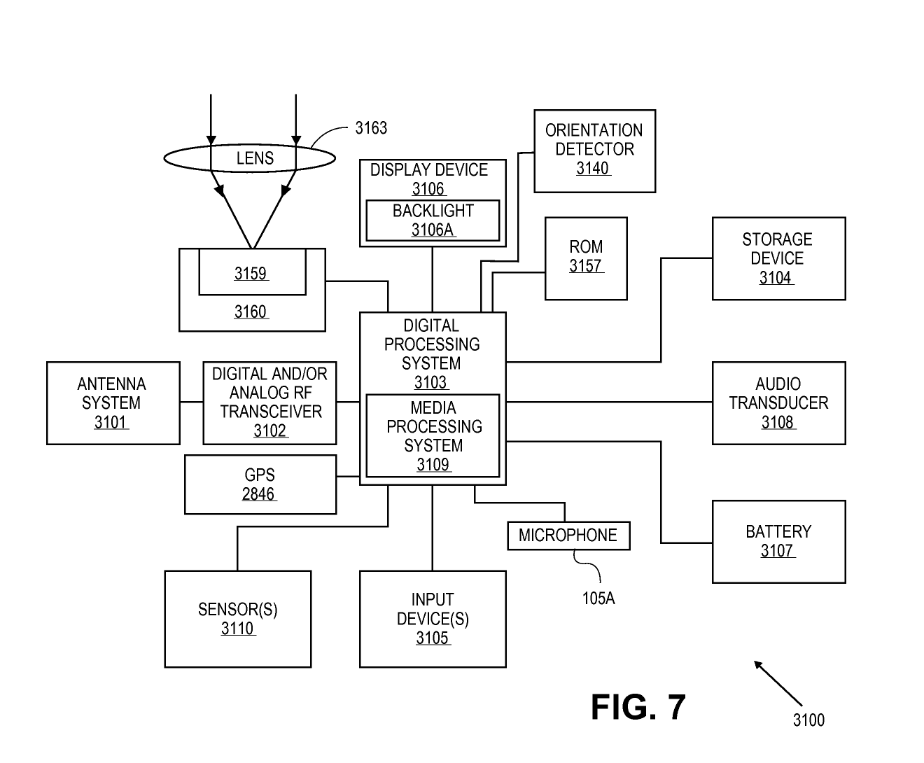

FIG. 7 shows an embodiment of a wireless image capturing device which includes the capability for wireless communication and for capturing images. Wireless device 3100 may include an antenna system 3101. Wireless device 3100 may also include a digital and/or analog radio frequency (RF) transceiver 3102, coupled to the antenna system 3101, to transmit and/or receive voice, digital data and/or media signals through antenna system 3101.

Wireless device 3100 may also include a digital processing system 3103 to control the digital RF transceiver and to manage the voice, digital data and/or media signals. Digital processing system 3103 may be a general purpose processing system, such as a microprocessor or controller for example. Digital processing system 3103 may also be a special purpose processing system, such as an ASIC (application specific integrated circuit), FPGA (field-programmable gate array) or DSP (digital signal processor). Digital processing system 3103 may also include other devices, as are known in the art, to interface with other components of wireless device 3100. For example, digital processing system 3103 may include analog-to-digital and digital-to-analog converters to interface with other components of wireless device 3100. Digital processing system 3103 may include a media processing system 3109, which may also include a general purpose or special purpose processing system to manage media, such as files of audio data.

Wireless device 3100 may also include a storage device 3104, coupled to the digital processing system, to store data and/or operating programs for the wireless device 3100. Storage device 3104 may be, for example, any type of solid-state or magnetic memory device. Storage device 3104 may be or include a machine-readable medium.

A machine-readable medium includes any mechanism for storing or transmitting information in a form readable by a machine (e.g., a computer). For example, machines store and communicate (internally and with other devices over a network) code and data using machine-readable media, such as machine storage media (e.g., magnetic disks; optical disks; random access memory; read only memory; flash memory devices; phase-change memory).

Wireless device 3100 may also include one or more input devices 3105, coupled to the digital processing system 3103, to accept user inputs (e.g., telephone numbers, names, addresses, media selections, etc.) Input device 3105 may be, for example, one or more of a keypad, a touchpad, a touch screen, a pointing device in combination with a display device or similar input device.

Wireless device 3100 may also include at least one display device 3106, coupled to the digital processing system 3103, to display information such as messages, telephone call information, contact information, pictures, movies and/or titles, global positioning information, compass information, or other indicators of media being selected via the input device 3105. Display device 3106 may be, for example, an LCD display device. In one embodiment, display device 3106 and input device 3105 may be integrated together in the same device (e.g., a touch screen LCD such as a multi-touch input panel which is integrated with a display device, such as an LCD display device). The display device 3106 may include a backlight 3106A to illuminate the display device 3106 under certain circumstances. It will be appreciated that the wireless device 3100 may include multiple displays.

Wireless device 3100 may also include a battery 3107 to supply operating power to components of the system including digital RF transceiver 3102, digital processing system 3103, storage device 3104, input device 3105, microphone 3105A, audio transducer 3108, media processing system 3109, sensor(s) 3110, and display device 3106, an image sensor 3159 (e.g., CCD (Charge Coupled Device), CMOS sensor). The image sensor may be integrated with an image processing unit 3160. The display device 3106 may include a Liquid Crystal Display (LCD) which may be used to display images which are captured or recorded by the wireless image capturing device 3100. The LCD serves as a viewfinder of a camera and there may optionally be other types of image display devices on device 3100 which can serve as a viewfinder.

The device 3100 also includes an imaging lens 3163 which can be disposed over image sensor 3159. The processing system 3103 controls the operation of the device 3100; and, it may do so by executing a software program stored in ROM 3157, or in the processing system 3103, or in both ROM 3157 and the processing system 3103.

The processing system 3103 controls the image processing operation; and, it controls the storage of a captured image in storage device 3104. The processing system 3103 also controls the exporting of image data (which may or may not be color corrected) to an external general purpose computer or special purpose computer.

The processing system 3103 also responds to user commands (e.g., a command to “take” a picture or video by capturing image(s) on the image sensor and storing it in memory or a command to select an option for contrast enhancement and color balance adjustment).

The ROM 3157 may store software instructions for execution by the processing system 3103 to perform the operations discussed in the present disclosure. The processing system 3103 sends and receives information to/from an image processing unit 3160 having a microprocessor and image sensors. The processing system 3103 may include hardware (circuitry, dedicated logic, etc.), software (such as is run on a general purpose computer system or a dedicated machine or a device), or a combination of both. The processing system 3103 may perform geotagging and send geographical identification metadata to the image processing unit that performs the image signal processing. Geotagging is the process of adding geographical identification metadata to various media such as photographs, video, websites, or RSS feeds and is a form of geospatial metadata. These data usually consist of latitude and longitude coordinates, though they can also include altitude, bearing, accuracy data, and place names.

The geographical identification metadata, time of day, and compass information can be sent by the processing system 3103 to the image processing unit 3160. The image processing unit 3160 performs adaptive image signal processing based on this information. Image parameters that may be adjusted include color adjustments (e.g., white balance, hue, saturation), sharpening, and contrast.

In some embodiments, a global positioning system (GPS) receiver 2846 detects GPS data. The processing system 3103 is coupled to the storage device 3104 and the GPS receiver 2846. The processing system 3103 is configured to capture image data, to receive GPS data from the GPS receiver during image capture; and to adjust image capture data during signal processing of the image capture data based on the GPS data. The image processing unit 3160 may be integrated with the system 3103 or external to the system 3103. The image processing unit 3160 may perform the signal processing and adjust this processing based on the data received from the processing system 3103.

In one embodiment, the adaptive image signal processing can occur based on the GPS data upon initial operation of the device. For example, a device may begin initial operation in a particular region. In this case, regional settings are applied based on the GPS data that indicates the particular region or location.

In another embodiment, the adaptive image signal processing can occur based on the GPS data upon each time that the device is placed in the image capture mode or each time an image or sequence of images is captured.

The processing system 3103 is further configured to adjust at least one of color saturation, white balance, sharpening, noise, frame rate, and contrast during signal processing of the image capture data. Alternatively, image processing unit 3160 may be configured to adjust one or more of these image parameters.

The device 3100 further includes an orientation detector 3140 (e.g., accelerometer, gyroscope, motion detector, tilt sensor such as a mercury switch, compass, or any combination thereof) detect orientation data. The processing system is further configured to determine data regarding orientation of the device during image capture and based on that data, further adjust image capture data during signal processing of the image capture data.

The storage device 3104 is used to store captured/recorded images which are received from the CCD 3159. It will be appreciated that other alternative architectures of a camera can be used with the various embodiments of the invention.

Battery 3107 may be, for example, a rechargeable or non-rechargeable lithium or nickel metal hydride battery. Wireless device 3100 may also include audio transducers 3108, which may include one or more speakers, and at least one microphone 3105A.

The device may further include a camera (e.g., lens 3163 and image sensor 3159) coupled to the processing system 3103 with the processing system 3103 being configured to detect which direction the lens is pointed (e.g., up, down, east, west, north, south).

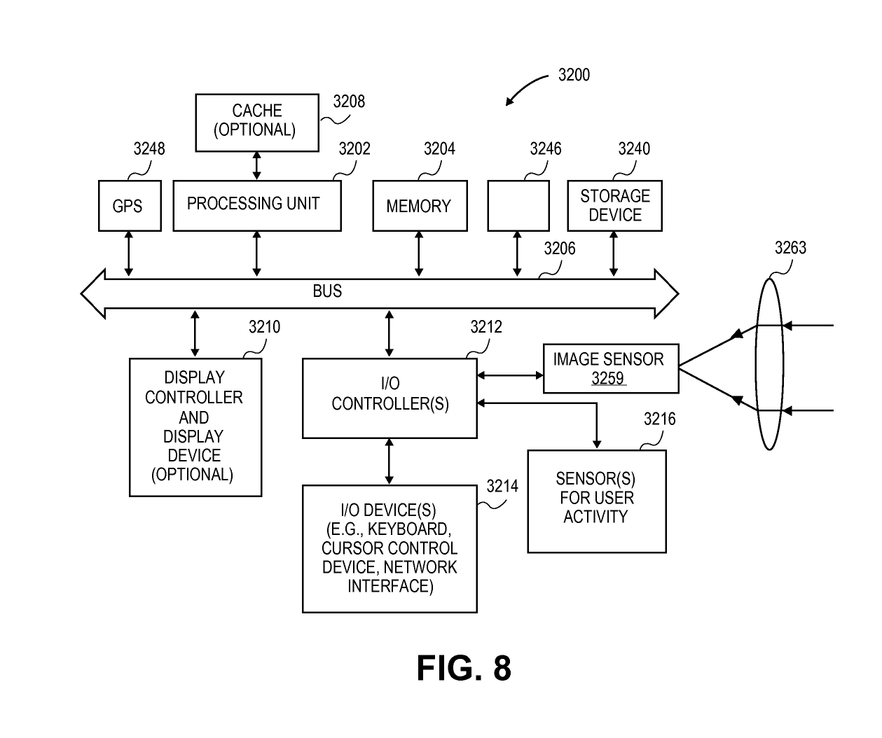

FIG. 8 shows an example of a data processing system according to an embodiment of the present invention. This data processing system 3200 may include a processor, such as processing unit 3202, and a memory 3204, which are coupled to each other through a bus 3206. The data processing system 3200 may optionally include a cache 3208 which is coupled to the processing unit 3202. The data processing system may optionally include a storage data processing system 3240 which may be, for example, any type of solid-state or magnetic memory data processing system. Storage data processing system 3240 may be or include a machine-readable medium.

This data processing system may also optionally include a display controller and display data processing system 3210 which is coupled to the other components through the bus 3206. One or more input/output controllers 3212 are also coupled to the bus 3206 to provide an interface for input/output data processing systems 3214 and to provide an interface for one or more sensors 3216 which are for sensing user activity. The bus 3206 may include one or more buses connected to each other through various bridges, controllers, and/or adapters as is well known in the art. The input/output data processing systems 3214 may include a keypad or keyboard or a cursor control data processing system such as a touch input panel. Furthermore, the input/output data processing systems 3214 may include a network interface which is either for a wired network or a wireless network (e.g. an RF transceiver). The sensors 3216 may be any one of the sensors described herein including, for example, a proximity sensor or an ambient light sensor. In at least certain implementations of the data processing system 3200, the processing unit 3202 may receive data from one or more sensors 3216 or from image sensor 3259 or from orientation detector 3246 or from GPS receiver 3248 and may perform the analysis of that data in the manner described herein. Image sensor 3259 captures an image via light focused by lens 3263.

In some embodiments, the data processing system 3200 includes the storage device 3240 to store a plurality of captured images and a global positioning system (GPS) 3248 to detect GPS data. An image sensor 3259 captures image data. The processing unit 3202 is coupled to the storage device and the GPS receiver 3248. The processing unit 3202 is configured to receive image data from the image sensor 3259, to receive GPS data from the GPS receiver, and to adjust image data adaptively during signal processing of the image data based on the GPS data.

The system 3200 may further include an orientation detector 3246 that detects orientation data. The processing unit 3202 is further configured to determine data regarding orientation of the device during image capture and based on that data, further adjust image capture data during signal processing of the image capture data.

In one embodiment, the adaptive image signal processing can occur based on the GPS receiver and/or orientation data upon initial operation of the device.

In another embodiment, the adaptive image signal processing can occur based on the GPS receiver and/or orientation data upon each time that the device is placed in the image capture mode or each time an image or sequence of images is captured.

In certain embodiments of the present disclosure, the data processing system 3200 can be used to implement at least some of the methods discussed in the present disclosure.

The methods of the present invention can be implemented using dedicated hardware (e.g., using Field Programmable Gate Arrays, or Application Specific Integrated Circuit, which many be integrated with image sensors, such as CCD or CMOS based image sensors) or shared circuitry (e.g., microprocessors or microcontrollers under control of program instructions stored in a machine readable medium, such as memory chips) for an imaging device, such as device 3100 in FIG. 7. The methods of the present invention can also be implemented as computer instructions for execution on a data processing system, such as system 3200 of FIG. 8.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method to adjust image parameters for an image capturing device, the method comprising:
determining data regarding location of the device during image capture; and
based on that data, adjusting image capture data during signal processing of the image capture data.

2. The method of claim 1, further comprising:
capturing an image based on the adjusted image capture data.

3. The method of claim 1, wherein adjusting image capture data during signal processing of the image capture data further comprises adjusting at least one of the following parameters: color saturation, white balance, sharpening, noise, frame rate, and contrast.

4. The method of claim 1, further comprising:
determining data regarding orientation of the device and time of day during image capture; and
based on that data, further adjusting image capture data during signal processing of the image capture data.

5. A machine readable medium containing executable computer program instructions which when executed by a data processing system cause said system to perform a method, the method comprising:
determining data regarding location of the device during image capture; and
based on that data, adjusting image capture data during signal processing of the image capture data.

6. The medium of claim 5, further comprising:
capturing an image based on the adjusted image capture data.

7. The medium of claim 5, wherein adjusting image capture data during signal processing of the image capture data further comprises adjusting at least one of the following parameters: color saturation, white balance, sharpening, noise, frame rate, and contrast.

8. The medium of claim 5, further comprising:
determining data regarding orientation of the device and time of day during image capture; and
based on that data, further adjusting image capture data during signal processing of the image capture data.

9. An image capturing device, comprising:
a storage device to store a plurality of captured images;
a global positioning system (GPS) receiver to generate GPS data; and
a processing system coupled to the storage device and the GPS receiver, the processing system is configured to capture image data, to receive GPS data from the GPS receiver during image capture; and to adjust image capture data during signal processing of the image capture data based on the GPS data.

10. The device of claim 9, wherein the processing system is further configured to capture an image based on the adjusted image capture data.

11. The device of claim 9, wherein the processing system is further configured to adjust at least one of the following parameters: color saturation, white balance, sharpening, noise, frame rate, and contrast during signal processing of the image capture data.

12. The device of claim 9, further comprising an orientation detector to detect orientation data, wherein the processing system is further configured to determine data regarding orientation of the device during image capture; and
based on that data, further adjust image capture data during signal processing of the image capture data.

13. A method to adjust image parameters for an image capturing device, the method comprising:
determining data regarding location of the device upon initial operation of the device; and
based on that data, adjusting image capture data during signal processing of the image capture data.

14. The method of claim 13, further comprising:
determining data regarding time of day and orientation of the device during image capture; and
based on that data, further adjusting image capture data during signal processing of the image capture data and wherein the data regarding location is stored for subsequent operations of the device.

15. The method of claim 13, wherein adjusting image capture data during signal processing of the image capture data further comprises adjusting at least one of the following parameters: color saturation, white balance, sharpening, noise, frame rate, and contrast.

16. A machine readable medium containing executable computer program instructions which when executed by a data processing system cause said system to perform a method, the method comprising:
determining data regarding location of the device upon initial operation of the device; and
based on that data, adjusting image capture data during signal processing of the image capture data.

17. The medium of claim 16, further comprising:
determining data regarding time of day and orientation of the device during image capture; and
based on that data, further adjusting image capture data during signal processing of the image capture data.

18. The medium of claim 16, wherein adjusting image capture data during signal processing of the image capture data further comprises adjusting at least one of the following parameters: color saturation, white balance, sharpening, noise, frame rate, and contrast.

19. A data processing system, comprising:
a storage device to store a plurality of captured images;
a global positioning system (GPS) to detect GPS data; and
a processing unit coupled to the storage device and the GPS, the processing unit is configured to capture image data, to receive GPS data from the GPS upon initial operation of the device; and to adjust image capture data during signal processing of the image capture data based on the GPS data.

20. The system of claim 19, further comprising an orientation detector to detect orientation data, wherein the processing unit is further configured to determine data regarding orientation of the device during image capture; and
based on that data, further adjust image capture data during signal processing of the image capture data.

21. The system of claim 19, wherein the orientation detector further comprises a gyroscope, an accelerometer, a motion detector, a tilt sensor, a compass, or any combination thereof.

22. A method to adjust image parameters for an image capturing device, the method comprising:
determining data regarding location of the device upon powering the device; and
based on that data, adjusting image capture data during signal processing of the image capture data.

23. The method of claim 22, wherein location of the device is determined with a global positioning system integrated with the device.

24. The method of claim 22, further comprising:
determining data regarding time of day and orientation of the device during image capture; and
based on that data, further adjusting image capture data during signal processing of the image capture data.

25. A method to adjust settings for an image capturing device, the method comprising:
determining data regarding regional location of the device;
determining one or more regulations associated with the regional location of the device; and
based on the one or more regulations, adjusting visual or audible settings during image capture of one or more images.

26. The method of claim 25, wherein regional location of the device is determined with a global positioning system integrated with the device.

27. The method of claim 25, wherein adjusting a visual setting further comprises flashing a light during image capture of one or more images.

28. The method of claim 25, wherein adjusting an audible setting further comprises generating an audible noise during image capture of one or more images.

29. A method to capture images with an image capturing device, the method comprising:
determining location data and orientation data of the device during image capture;
capturing one or more images with the device using image settings;
saving the image settings and associated location data and orientation data to build a database in the device;
determining current location data and orientation data for the device for a current frame or upon initiation of image capture mode;
comparing the current location data and orientation data with the previously saved location data and orientation data.

30. The method of claim 29, further comprising:
determining if the current location data and orientation data approximately match any of the previously saved location data and orientation data;
applying image settings associated with previously saved location data and orientation data if this data approximately matches the current location data and orientation data.
